(19) United States
(12) Patent Application Publication
(10) Pub. No.: US 2014/0168105 A1
(43) Pub. Date: Jun. 19, 2014

(54) ELECTRONIC DEVICE AND METHOD FOR PROVIDING TACTILE STIMULATION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: SHANG-QING ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/730,617

(22) Filed: Dec. 28, 2012

(30) Foreign Application Priority Data
Dec. 18, 2012 (CN) 201210552357.1

(51) Int. Cl. G06F 3/041

(52) U.S. Cl. CPC G06F 3/041
USPC 345/173

(57) ABSTRACT

A method for providing tactile stimulation is applied in an electronic device. The electronic device includes a touch-sensitive screen and a tactile stimulation multilayer connected to the touch-sensitive screen. The tactile stimulation multilayer includes a number of electrodes. The method includes the steps of; detecting a touch operation on the touch-sensitive screen; determining location information of touched locations of the touch operation; extracting a sub-image covered by the touched locations from the displayed image and identifying objects comprised in the sub-image according to features of the sub-image; determining a number of electrodes corresponding to one touched location and electrical parameters respectively corresponding to the objects comprised in the sub-image; and energizing the electrodes at the determined location according to the determined electrical parameters.

### BACKGROUND

1. Technical Field

The present disclosure relates to electronic devices, and particularly, to an electronic device and a method for providing tactile stimulation adapted for the electronic device.

2. Description of Related Art

Many electronic devices, such as mobile phones, tablet computers, and multimedia players, employ touch-sensitive screens as input interfaces. However, a touch-sensitive screen does not provide very good tactile feedback to the user touching on the touch-sensitive screen as a conventional keyboard does which has a greater key-travel distance for a keystroke when operated. In order to improve the user experience, a number of vibrating mechanical members are arranged under the touch-sensitive screen. When sensing a touch operation on the touch-sensitive screen, the vibrating mechanical member at the point of touch begins to vibrate to provide tactile feedback to the user. However, a problem shared by most such electronic devices is that the electronic devices provide the same tactile sensations even when he or she touches different contents displayed on the touch-sensitive screen, which is an unsophisticated and undeveloped arrangement.

The technology of enabling the touch-sensitive screen to provide tactile feedback can be realized by delivering an electrosensory sensation in response to a touch operation on the touch-sensitive screen. However, the development of this kind of tactile feedback is not complete or satisfactory.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a perspective view of a touch-sensitive screen included in an electronic device, in accordance with an exemplary embodiment.

FIG. 2 is a perspective view of a tactile stimulation multilayer connected to the touch-sensitive screen of FIG.1, in accordance with an exemplary embodiment.

FIG. 3 is a block diagram of a tactile stimulation system applied to the electronic device of FIG. 1, in accordance with an exemplary embodiment.

FIG. 4 is a schematic view showing a user interface on the touch-sensitive screen of FIG. 1, in accordance with an embodiment.

FIG. 5 is a block diagram of a tactile stimulation system applied to the electronic device of FIG. 1, in accordance with another exemplary embodiment.

FIG. 6 is a flowchart of a method for providing tactile stimulation, in accordance with an exemplary embodiment.

FIG. 7 is a flowchart of a method for providing tactile stimulation, in accordance with another exemplary embodiment.

### DETAILED DESCRIPTION

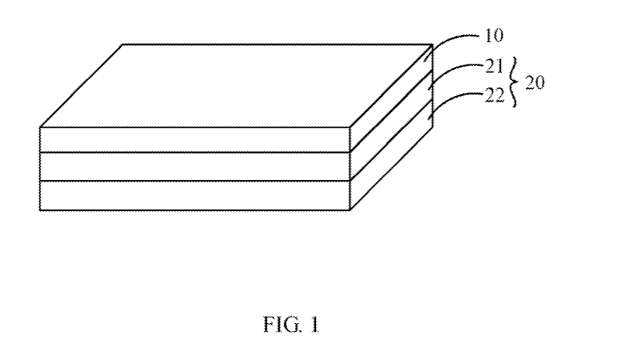

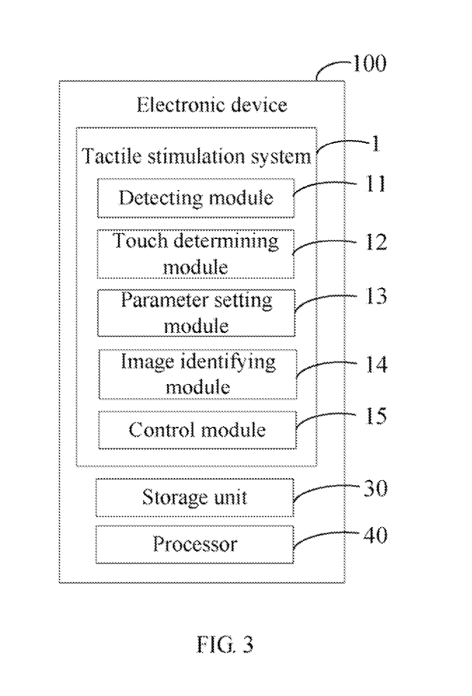

FIG. 1 is a perspective view of a touch-sensitive screen 10 of an electronic device 100 according to an exemplary embodiment. The electronic device 100 may be a mobile phone, a tablet computer, or a multimedia player for example. A tactile stimulation multilayer 20 is connected to the screen 10, and is arranged above or under the screen 10. The multilayer 20 includes a number of electrodes 220 (further shown in FIG. 3) which can be independently controlled. The electronic device 100 further includes a storage unit 30 and a processor 40 (further shown in FIG. 3). The storage unit 30 stores a first relationship between a number of locations on the screen 10 and the electrodes 220, and each location corresponds to one electrode 220. The storage unit 30 further stores a tactile stimulation system 1. The system 1 includes a variety of modules executed by the processor 40 to provide the functions of the system 1. In this embodiment, the system 1 is executed by the processor 40, when touch operations on the screen 10 by a fingertip, by employing location information of the touch operation and then energizing the corresponding electrode 220 in the multilayer 20, to provide tactile stimulation.

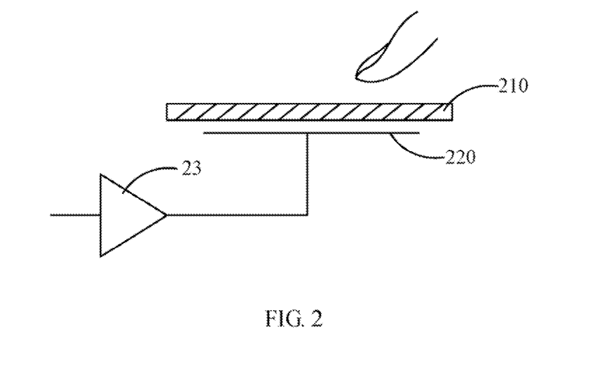

FIG. 2 shows that the multilayer 20 includes an insulation layer 21 and an electrode layer 22. The said electrodes 220 are included in the electrode layer 22. The electrodes 220 are connected to a power supply unit 23, and can be independently energized via the power supply unit 23. The insulation layer 21 includes a number of insulators 210, and each insulator 210 corresponds to one electrode 220. In the embodiment, the multilayer 20 is arranged under the screen 10, and the insulation layer 21 is arranged between the multilayer 20 and the electrode layer 22. Furthermore, when a body member such as a fingertip, which is a relatively good insulator when dry, touches the multilayer 20, the body member and the multilayer 20 cooperatively form a capacitor. Then, the system 1 determines the location of the body member on the screen 10 and energizes the electrode 220 corresponding to the determined location via the power supply unit 23, thus, static electrical charges flow to the body member because of a capacitive coupling between the determined electrode 220 and the body member, and a tactile stimulation is delivered to the body member.

FIG. 3 shows that in the embodiment, the system 1 includes a detecting module 11, a touch determining module 12, a parameter setting module 13, an image identifying module 14, and a control module 15.

The detecting module 11 detects a touch operation on the screen 10 according to signals from the screen 10.

The touch determining module 12 determines location information of touched locations. Specifically, when a body member touches the screen 10, a number of locations of the screen 10 are simultaneously touched, thus each time when a touch operation is executed, location information of a number of touched locations are determined.

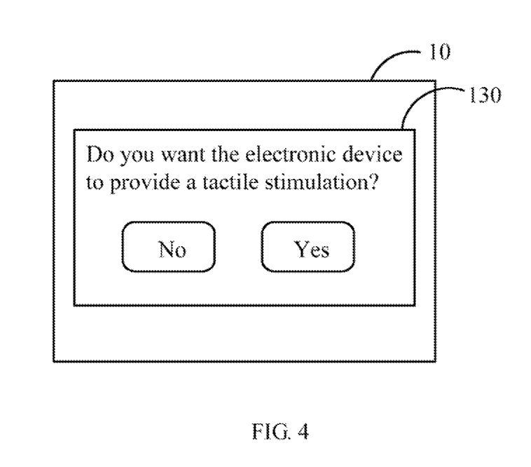

The parameter setting module 13 provides a user interface 130 (see FIG. 4) on the screen 10 for a user to select whether to allow the electronic device 100 to provide a tactile stimulation. In this embodiment, the user interface 130 includes a yes option and a no option. If the no option is selected, the processor 40 performs a variety of basic functions in response to the touch operation, such as zoom, page, and scroll functions, without providing tactile stimulation. If the yes option is selected, the processor 40 performs the basic functions in response to the touch operation with the addition of tactile stimulation.

The applications running on the electronic device 100 may be a game, or an image viewer for example. When the application runs, the electronic device 100 enters a predetermined mode of the running application and then displays an image including at least one object set by the mode on the screen 10. For example, when a racing game is run, the electronic device 100 enters a corresponding scene mode of the racing game and then displays objects including lanes, obstacles, tools to be selected, and awards. When an image viewer is run, the electronic device 100 enters the image viewing mode and then displays images of objects, such as sea, sandy beach, and trees for example.

The image identifying module 14 extracts a sub-image covered by the touched locations from the displayed image if the parameter setting module 13 determines that the electronic device 100 is to provide a tactile stimulation, and then identifies the objects included in the sub-image according to features of the sub-image. In the embodiment, the features of the sub-image may be the texture, the brightness difference, and the outline of the objects included in the sub-image. In the embodiment, the image identifying module 14 detects an outline of each object included in the sub-image according to a brightness difference between the object and the background, and then compares the detected outline of the object with different standard outlines of object models stored in the storage unit 30, to identify the objects included in the sub-image.

The control module 15 determines a number of electrodes 220 corresponding to one touched location according to the first relationship between the locations and the electrodes 220, and determines electrical parameters respectively corresponding to the objects included in the sub-image, according to a second relationship between different objects and electrical parameters stored in the storage unit 30. Then, the control module 15 energizes the determined electrodes 220 via the power supply unit 23 with the determined electrical parameters. Thus, the system 1 brings an improved tactile stimulation to the body member touching the screen 10 by making virtual objects displayed on the screen 10 come alive. In the embodiment, the electrical parameter may be the amplitude, or the wave frequency of the electricity energizing the electrodes 220.

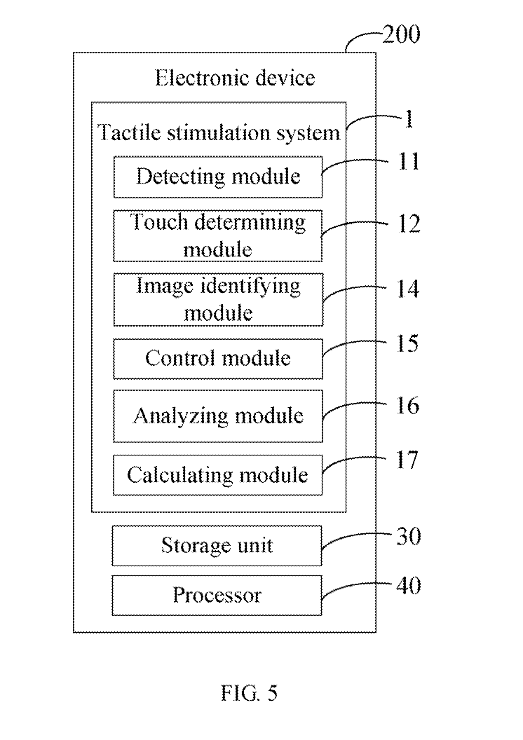

FIG. 5 shows that in an alternative embodiment, the parameter setting module 13 is absent from the system 1, and the electronic device 200 is inherently allowed to provide tactile stimulation. In the alternative embodiment, the system 1 includes the detecting module 11, the touch determining module 12, the image identifying module 14, the control module 15, an analyzing module 16, and a calculating module 17. The above mentioned functions of the detecting module 11, the touch determining module 12, the image identifying module 14, and the control module 15 will not be repeated in this embodiment. In the alternative embodiment, the touch determining module 12 further determines an occurrence time of touching each touched location. The analyzing module 16 extracts a number of successively detected touched locations and determines whether the touch operation on the screen 10 is a slide operation according to the location information of each determined touched locations. The calculating module 17 calculates an anticipated trajectory of the slide operation according to the location information and occurrence time of each determined touched location if the touch operation is determined to be a slide operation. The anticipated trajectory may be a subsequent touch point of the slide operation including new touched locations touched after the successively detected touched locations, enabling a slide trajectory to be established. The image identifying module 14 further extracts a new sub-image covered by the new touched locations of the anticipated trajectory from the displayed image, and then determines objects included in the new sub-image according to the features of the new sub-image. The control module 15 further determines a number of electrodes 220 each corresponding to one new touched location along the anticipated trajectory according to the first relationship, determines electrical parameters respectively corresponding to the objects included in the new sub-image according to the second relationship, and energizes the determined electrodes 220 via the power supply unit 23 with the determined electrical parameters, thereby a tactile stimulation is as far as possible provided in advance before the body member actually touches the screen view of the new sub-image, to avoid any delay of the tactile stimulation.

In the alternative embodiment, the image identifying module 14 does not first determine the objects included in the new sub-image after extracting the new sub-image from the displayed image. Instead, after extracting the new sub-image from the displayed image, the image identifying module 14 compares the features of the new sub-image with that of the previous sub-image. If a difference between the features of the new sub-image and the previous sub-image is within a predetermined range, the control module 15 determines that the new sub-image and the previous sub-image have the same objects, and energizes the electrodes 220 corresponding to the new touched locations to the same extent as the electrical parameters applied to the objects included in the previous sub-image. Thus, the processing burden on the processor 40 can be significantly reduced.

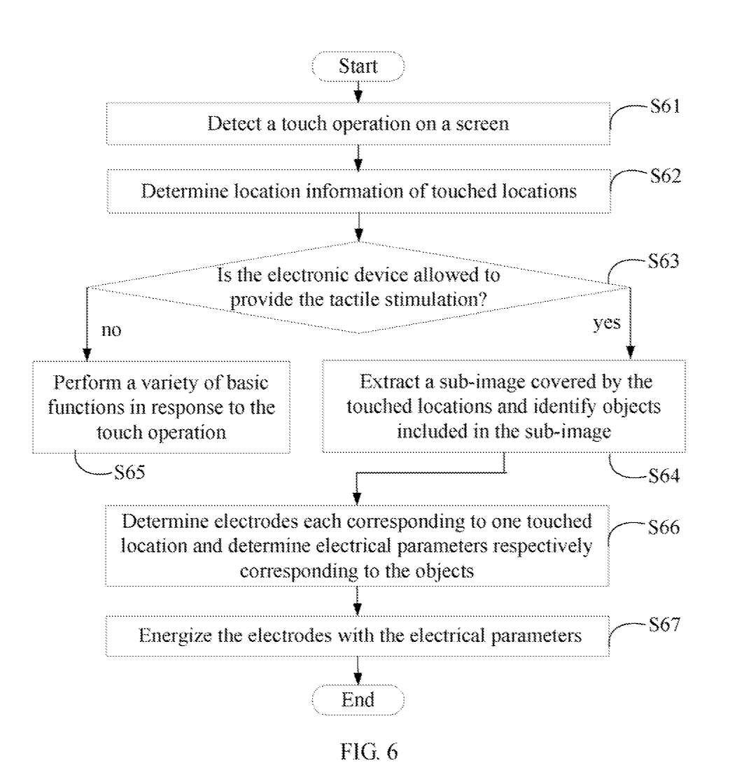

FIG. 6 is a flowchart of a method for providing tactile stimulation applied in the electronic device 100 of FIG. 3, in accordance with an exemplary embodiment.

In step S61, the detecting module 11 detects a touch operation on the screen 10 according to signals from the screen 10.

In step S62, the touch determining module 12 determines location information of touched locations.

In step S63, the parameter setting module 13 determines whether the electronic device 100 is to provide a tactile stimulation according to a selection by the user through the user interface 130; if yes, the procedure goes to step S64, otherwise, the procedure goes to step S65.

In step S64, the image identifying module 14 extracts a sub-image covered by the touched locations from an image displayed on the screen 10, and identifies objects included in the sub-image according to features of the sub-image.

In step S65, the processor 40 performs a variety of basic functions, such as zoom, page, and scroll functions in response to the touch operation without providing tactile stimulation.

In step S66, the control module 15 determines a number of electrodes 220 corresponding to one touched location, according to the first relationship between the locations and the electrodes 220, and determines electrical parameters respectively corresponding to the objects included in the sub-image, according to a second relationship between different objects and electrical parameters stored in the storage unit 30.

In step S67, the control module 15 energizes the determined electrodes 220 via the power supply unit 23 according to the determined electrical parameters. In the embodiment, the electrical parameters may be the amplitude or the wave frequency of the electricity energizing the electrodes 220.

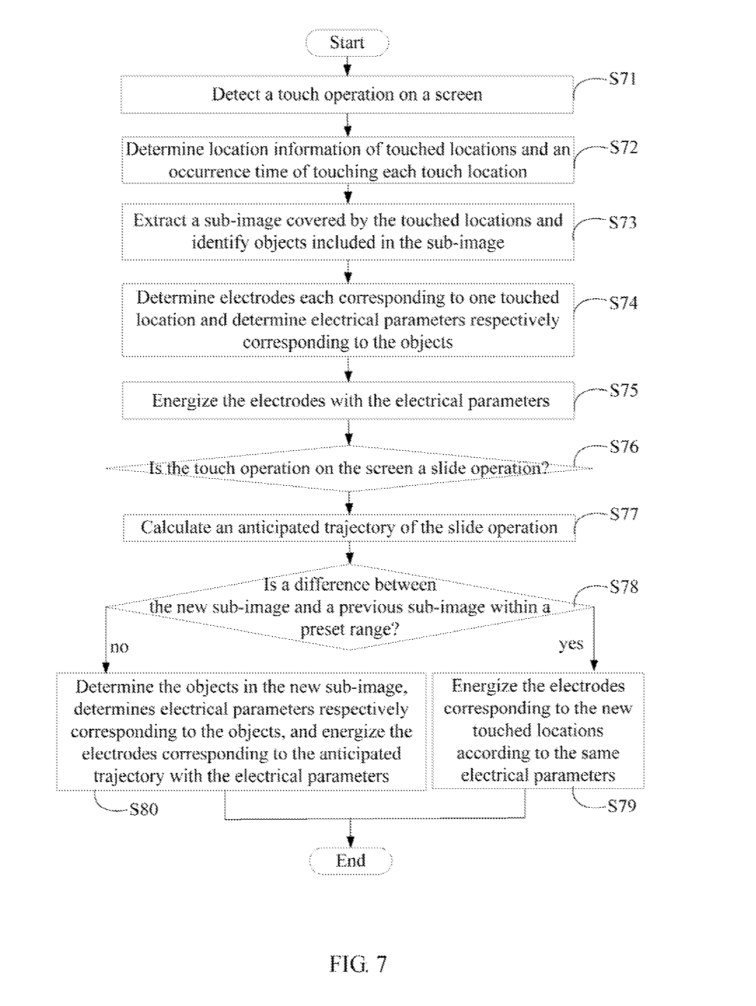

FIG. 7 is a flowchart of a method for providing tactile stimulation applied in the electronic device 200 of FIG. 5, in accordance with another exemplary embodiment.

In step S71, the detecting module 11 detects a touch operation on the screen 10 according to signals from the screen 10.

In step S72, the touch determining module 12 determines location information of touched locations of the touch operation and an occurrence time of touching each touch point.

In step S73, the image identifying module 14 extracts a sub-image covered by the touched locations, from an image displayed on the screen 10, and identifies objects included in the sub-image according to features of the sub-image.

In step S74, the control module 15 determines a number of electrodes 220 corresponding to one touched location, according to the first relationship between the locations and the electrodes 220, and determines electrical parameters respectively corresponding to the objects included in the sub-image, according to a second relationship between different objects and electrical parameters stored in the storage unit 30.

In step S75, the control module 15 energizes the determined electrodes 220 via the power supply unit 23 in accordance with the determined electrical parameters. In the embodiment, the electrical parameters may be the amplitude or the wave frequency of the electricity energizing the electrodes 220.

In step S76, the analyzing module 16 extracts a number of successively detected touched locations and determines whether the touch operation on the screen 10 is a slide operation, according to the location information of each extracted touched location; if yes, the procedure goes to step S77, otherwise, the procedure goes back to step S71.

In step S77, the calculating module 17 calculates an anticipated trajectory of the slide operation according to the location information and occurrence time of each determined touched location. The anticipated trajectory may be a subsequent touch trajectory of the slide operation, and the subsequent touch trajectory includes new touched locations touched after the earlier successively detected touched locations.

In step S78, the image identifying module 14 extracts a new sub-image covered by the new touched locations along the anticipated trajectory from the displayed image, and compares the features of the new sub-image with that of the previous sub-image. If a difference between the features of the new sub-image and the previous sub-image is within a predetermined range, the procedure goes to step S79, otherwise, the procedure goes to step S80.

In step S79, the control module 15 determines that the new sub-image and the previous sub-image have the same objects, and energizes the determined electrodes 220 corresponding to the new touched locations according to the same electrical parameters as were applied to the objects included in the previous sub-image.

In step S80, the image identifying module 14 determines the objects included in the new sub-image according to the features of the new sub-image, and the control module 15 determines electrical parameters respectively corresponding to the objects included in the new sub-image according to the second relationship, and energizes the electrodes 220 corresponding to the new touched locations along the anticipated trajectory via the power supply unit 23, according to the determined electrical parameters.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch-sensitive screen;
a tactile stimulation multilayer connected to the touch-sensitive screen, the tactile stimulation multilayer comprising a plurality of electrodes;
a storage unit storing a plurality of modules, a first relationship between locations of the touch-sensitive screen and the electrodes, each location corresponding to one of the electrodes, and a second relationship between different objects and electrical parameters energizing the electrodes;
a processor to execute a plurality of modules, and the plurality of modules comprising:
a detecting module to detect a touch operation according to touch signals from the touch-sensitive screen;
a touch determining module to determine location information of touched locations of the touch operation;
an image identifying module to extract a sub-image covered by the touched locations from an image displayed on the touch-sensitive screen, and identify objects comprised in the sub-image according to features of the sub-image; and
a control module to determine a plurality of electrodes each corresponding to one touched location according to the first relationship between the locations and the electrodes, determine electrical parameters respectively corresponding to the objects comprised in the sub-image according to the second relationship between different objects and electrical parameters, and energize the determined electrodes via a power supply unit with the determined electrical parameters.

2. The electronic device of claim 1, wherein the plurality of modules further comprises a parameter setting module configured to provide a user interface on the touch-sensitive screen for a user to select whether to allow the electronic device to provide a tactile stimulation when the electronic device runs an application; and the image identifying module is configured to extract the sub-image covered by the touched locations from the displayed image when the parameter setting module determines that the electronic device is allowed to provide a tactile stimulation according to a selection by the user through the user interface.

3. The electronic device of claim 2, wherein the user selecting interface comprises a yes option and a no option; the processor is configured to perform a variety of basic functions in response to the touch operation without providing tactile stimulation if the no option is selected, and perform the basic functions in response to the touch operation with providing a tactile stimulation if the yes option is selected.

4. The electronic device of claim 1, wherein the electrical parameter is an amplitude or wave frequency of the electricity energizing the electrodes.

5. The electronic device of claim 1, wherein the image identifying module is configured to detect an outline of each object comprised in the sub-image according to a brightness difference between the object and a background in the sub-image, and compare the detected outline of the object with different standard outlines of object models stored in the storage unit to identify the objects comprised in the sub-image.

6. The electronic device of claim 1, wherein the touch determining module is further configured to determine an occurrence time of touching each touched location; the plurality of modules further comprises an analyzing module and a calculating module; the analyzing module is configured to extract a plurality of successively detected touched locations and determine whether the touch operation is a slide operation according to the location information of each extracted touched locations; the calculating module is configured to calculate an anticipated trajectory of the slide operation according to the location information and occurrence time of each extracted touched locations if the touch operation is determined to be a slide operation; and the control module is further configured to determine a plurality of electrodes each corresponding to one new touched location along the anticipated trajectory according to the first relationship, and then energized the determined electrodes via the power supply unit, thereby a tactile stimulation is provided in advance at the anticipated trajectory.

7. The electronic device of claim 6, wherein the image identifying module is further configured to extract a new sub-image covered by the new touched locations along the anticipated trajectory from the displayed image, and determine objects comprised in the new sub-image according to the features of the new sub-image; and the control module is further configured to determine electrical parameters respectively corresponding to the objects comprised in the new sub-image according to the second relationship, and energize the determined electrodes via the power supply unit with the determined electrical parameters.

8. The electronic device of claim 6, wherein the image identifying module is further configured to extract a new sub-image covered by the new touched locations forming the anticipated trajectory from the displayed image, compare features of the new sub-image with that of a previous sub-image; and the control module is configured to determine that the new sub-image and the previous sub-image have the same objects if a difference between the features of the new sub-image and the previous sub-image is within a predetermined range, and energize the determined electrodes corresponding to the new touched locations according to the same electrical parameters as were applied to the objects comprised in the previous sub-image.

9. A method for providing tactile stimulation applied in an electronic device, the electronic device comprising a touch-sensitive screen and a tactile stimulation multilayer connected to the touch-sensitive screen, the tactile stimulation multilayer comprising a plurality of electrodes, the method comprising:
detecting a touch operation according to touch signals from the touch-sensitive screen;
determining location information of touched locations of the touch operation;
extracting a sub-image covered by the touched locations from an image displayed on the touch-sensitive screen, and identifying objects comprised in the sub-image according to features of the sub-image;
determining a plurality of electrodes each corresponding to one touched location according to a first relationship between the locations of the touch-sensitive screen and the electrodes stored in a storage unit of the electronic device;
determining electrical parameters respectively corresponding to the objects comprised in the sub-image according to a second relationship between different objects and electrical parameters energizing the electrodes stored in the storage unit; and
energizing the determined electrodes via a power supply unit with the determined electrical parameters.

10. The method of claim 9, wherein the step energizing the determined electrodes via a power supply unit with the determined electrical parameters further comprises:
determine an occurrence time of touching each touched location;
extracting a plurality of successively detected touched locations and determining whether the touch operation is a slide operation according to the location information of each extracted touched locations;
calculating an anticipated trajectory of the slide operation according to the location information and occurrence time of each extracted touched locations if the touch operation is determined to be a slide operation;
determining a plurality of electrodes each corresponding to one new touched location along the anticipated trajectory according to the first relationship and energizing the determined electrodes via the power supply unit.

11. The method of claim 10, wherein the step determining a plurality of electrodes each corresponding to one new touched location along the anticipated trajectory according to the first relationship and energizing the determined electrodes via the power supply unit further comprises:
extracting a new sub-image covered by the new touched locations along the anticipated trajectory from the displayed image;
determining objects comprised in the new sub-image according to the features of the new sub-image; and
determining electrical parameters respectively corresponding to the objects comprised in the new sub-image according to the second relationship, and energizing the determined electrodes via the power supply unit with the determined electrical parameters.

12. The method of claim 10, wherein the step determining a plurality of electrodes each corresponding to one new touched location along the anticipated trajectory according to the first relationship and energizing the determined electrodes via the power supply unit further comprises:
extracting a new sub-image covered by the new touched locations forming the anticipated trajectory from the displayed image;
comparing features of the new sub-image with that of a previous sub-image;
determining that the new sub-image and the previous sub-image have the same objects if a difference between the features of the new sub-image and the previous sub-image is within a predetermined range; and
energizing the determined electrodes corresponding to the new touched locations according to the same electrical parameters as were applied to the objects comprised in the previous sub-image.

13. A storage medium storing a plurality of modules, the plurality of modules comprising instructions executable by a processor of an electronic device to perform a method for providing tactile stimulation, the electronic device comprising a touch-sensitive screen and a tactile stimulation multilayer connected to the touch-sensitive screen, the tactile stimulation multilayer comprising a plurality of electrodes, the method comprising:
detecting a touch operation according to touch signals from the touch-sensitive screen;
determining location information of touched locations of the touch operation;
extracting a sub-image covered by the touched locations from an image displayed on the touch-sensitive screen, and identifying objects comprised in the sub-image according to features of the sub-image;
determining a plurality of electrodes each corresponding to one touched location according to a first relationship between the locations of the touch-sensitive screen and the electrodes;
determining electrical parameters respectively corresponding to the objects comprised in the sub-image according to a second relationship between different objects and electrical parameters energizing the electrodes; and
energizing the determined electrodes via a power supply unit with the determined electrical parameters.
